(19) United States
(12) Patent Application Publication
(10) Pub. No.: US 2015/0123901 A1
(43) Pub. Date: May 7, 2015

(54) GESTURE DISAMBIGUATION USING ORIENTATION INFORMATION

(71) Applicant: Microsoft Corporation, Redmond, WA (US)

(72) Inventors: Mark Schwesinger, Bellevue, WA (US); Emily Yang, Seattle, WA (US); Jay Kapur, Redmond, WA (US); Sergio Paolantonio, Seattle, WA (US); Christian Klein, Duvall, WA (US)

(73) Assignee: Microsoft Corporation, Redmond, WA (US)

(21) Appl. No.: 14/071,299

(22) Filed: Nov. 4, 2013

(51) Int. Cl. G06F 3/01

(52) U.S. Cl. CPC G06F 3/017
USPC 345/158

(57) ABSTRACT

Embodiments are disclosed that relate to controlling a computing device based upon gesture input. In one embodiment, orientation information of the human subject is received, wherein the orientation information includes information regarding an orientation of a first body part and an orientation of a second body part. A gesture performed by the first body part is identified based on the orientation information, and an orientation of the second body part is identified based on the orientation information. A mapping of the gesture to an action performed by the computing device is determined based on the orientation of the second body part.

### BACKGROUND

Natural user-input (NUI) technologies aim to provide intuitive modes of interaction between computing systems and human beings. For example, a human subject's motion input may be recognized as a gesture, and the gesture may be mapped to an action performed by a computing device. Such motions may be captured by image sensors, including but not limited to depth sensors and/or two-dimensional image sensors, as well as other motion-detecting mechanisms.

### SUMMARY

Various embodiments relating to controlling a computing device based on motion of a human subject are disclosed. In one embodiment, orientation information of the human subject may be received. The orientation information may include information regarding an orientation of a first body part and an orientation of a second body part. A gesture performed by the first body part may be identified based on the orientation information, and an orientation of the second body part may be identified based on the orientation information. Further, a mapping of the gesture to an action performed by the computing device may be determined based on the orientation of the second body part.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an environment in which NUI is used to control a computing or game system in accordance with an embodiment of this disclosure.

FIG. 2 shows an NUI pipeline in accordance with an embodiment of this disclosure.

FIG. 3 shows a method for controlling a computing device based on motion of a human subject in accordance with an embodiment of this disclosure.

FIG. 4 shows a method for controlling a computing device based on motion of a human subject in accordance with another embodiment of this disclosure.

FIGS. 5-7 show example scenarios where a gesture performed by a human subject's arm is mapped differently based on an orientation of the human subject's head.

FIGS. 8-10 show example scenarios where a gesture performed by a human subject's arm is mapped differently based on an orientation of the human subject's legs.

FIGS. 11 and 12 show example scenarios where a gesture is mapped differently based on an orientation of a human subject's hands relative to the human subject's head.

FIGS. 13-15 show example scenarios where a gesture is mapped differently based on an orientation of a human subject's hand.

FIG. 16 shows a computing system and an NUI interface system in accordance with an embodiment of this disclosure.

### DETAILED DESCRIPTION

Current gesture based NUI may utilize only parts of the human subject's body that directly generate the motion to recognize a gesture. For example, a tapping gesture may be recognized based on motion of a single finger, without considering other parts of the body. As another example, a scrolling or swiping gesture may be recognized only based on motion of a hand. In these examples, other parts of the body that do not play a role in performing the gesture may be ignored in the gesture recognition process.

Accordingly, embodiments are disclosed that relate to determining a mapping of a gesture performed by a first body part of the human subject to an action performed by a computing device based on an orientation of a second body part of the human subject. Although the second body part may not be involved in performing the gesture, the orientation of the second body part may provide contextual information of the human subject that may be used to map an action to the gesture that most accurately matches the context. Moreover, in some cases, such contextual information may be used to filter out false positive gesture recognitions. For example if a user is not looking at a display displaying a user interface that they are trying to navigate, a gesture mapped to an action to control the user interface may be ignored in this context. This may facilitate the accurate recognition of gestures relative to an approach that determines mapping of a gesture to an action merely based on a body part that performed the gesture.

In some embodiments, a gesture may be of a particular gesture type having a plurality of gesture instances, wherein the plurality of gesture instances may be mapped to different actions. Accordingly, a gesture instance of a gesture type performed by the first body part may be determined based on the orientation of the second body part and an action mapped to the gesture instance may be performed to control operation of the computing device. In such embodiments, the contextual information provided by the orientation of the second body part may be used to differentiate between different gesture instances of a particular gesture type.

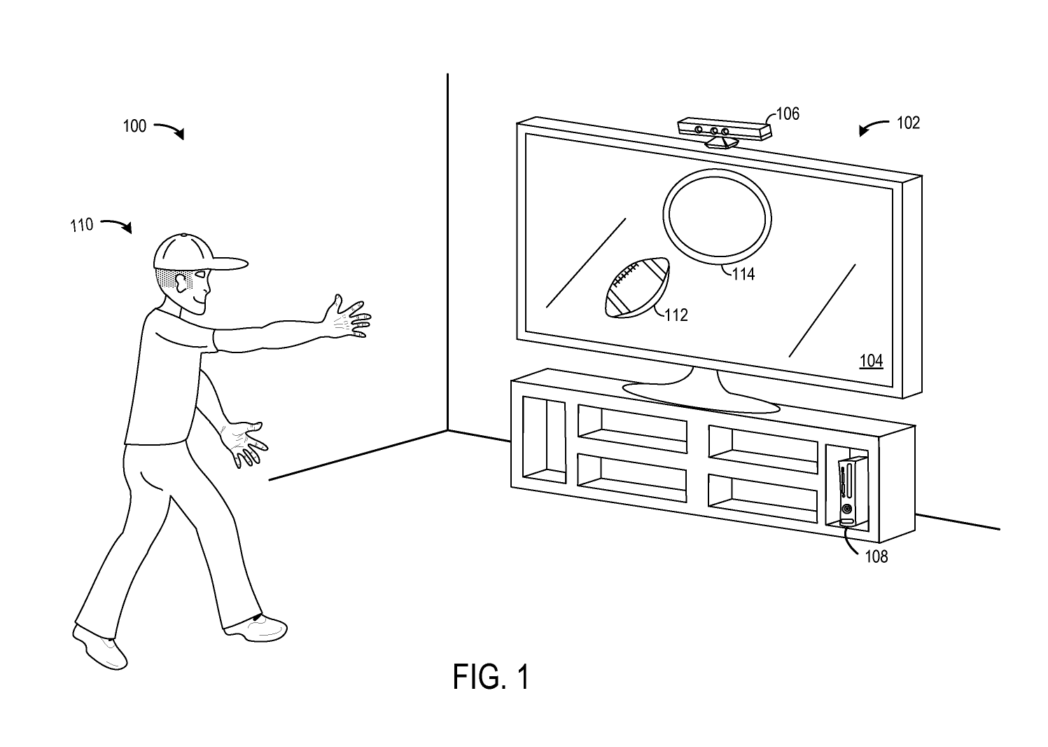

FIG. 1 shows aspects of an example use environment 100. The illustrated environment 100 is a living room or family room of a personal residence. However, the approaches described herein may be used in any other suitable environments, such as retail stores and kiosks, restaurants, information kiosks, public-service environments, etc. In the environment 100, a home-entertainment system 102 is installed. The home-entertainment system includes a display 104 and an NUI interface system 106, both operatively coupled to a computing system 108. The computing and NUI interface systems may be coupled via a wired link, a wireless link, or in another suitable manner. In the illustrated embodiment, the display presents computer-generated imagery (still images, video, graphical user interface elements, etc.). The computing system may be a video-game system; a multimedia system configured to play music and/or video; a general-purpose computing system used for internet browsing and productivity applications; and/or any other suitable type of computing system, including mobile computing systems, without departing from the scope of this disclosure.

The computing system 108 may be configured to accept various forms of user input. As such, traditional user-input devices such as a keyboard, mouse, touch-screen, gamepad, or joystick controller may be operatively coupled to the computing system. Regardless of whether traditional user-input modalities are supported, the computing system 108 accepts so-called natural user input (NUI) from at least one human subject 110. In the scenario represented in FIG. 1, the human subject is standing; in other scenarios, the human subject may be lying down, seated, or in any other posture.

The NUI interface system 106 may include various sensors for tracking the human subject. For example, the NUI interface system may include depth camera(s), visible light (e.g., RGB color) camera(s), and/or microphone(s). For example, such sensors may track motion and/or voice input of the human subject. In other embodiments, additional and/or different sensors may be utilized.

In the illustrated example, a virtual environment is presented on the display 104. The virtual environment includes a virtual football 112 that may be guided through a virtual ring 114 via motion of the human subject 110. In particular, the NUI interface system 106 images the human subject mimicking a throwing motion with his right arm. The video input is sent to the computing system 108, which identifies a throwing gesture based on an orientation of the right arm throughout the course of the throwing motion. The throwing gesture is mapped to an action performed by the computing device. In particular, the action manipulates a path of virtual football in the virtual environment. For example, the speed and motion path of the throwing gesture may determine the flight path of the virtual football in the virtual environment.

It will be understood that the illustrated virtual football scenario is provided to demonstrate a general concept, and the imaging, and subsequent modeling, of human subject(s) and or object(s) within a scene may be used to perform a variety of different actions performed by the computing device in a variety of different applications without departing from the scope of this disclosure.

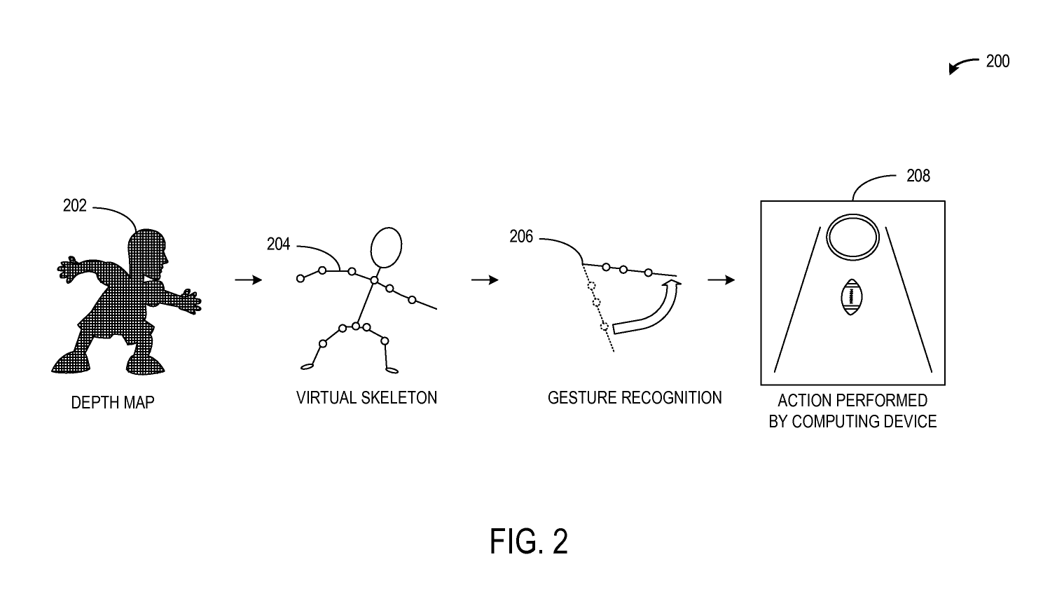

FIG. 2 graphically shows a simplified NUI pipeline 200 that may be used to track motion of a human subject and control aspects of a computing device. It will be appreciated that the NUI pipeline may be implemented by any suitable computing system without departing from the scope of this disclosure. For example, the NUI interface system 106 and/or the computing system 108 may implement the NUI pipeline. It will be understood that the NUI pipeline may include additional and/or different processing steps than those illustrated without departing from the scope of this disclosure.

The NUI interface system may output various streams of information associated with different sensors of the NUI interface system. For example, the NUI interface system may output depth image information from one or more depth cameras, infrared (IR) image information from the one or more depth cameras, and color image information from one or more visible light cameras.

A depth map 202 may be output by the one or more depth cameras and/or generated from the depth image information output by the one or more depth cameras. The depth map may be made up of depth pixels that indicate a depth of a corresponding surface in the observed environment relative to the depth camera. It will be understood that the depth map may be determined via any suitable mechanisms or combination of mechanisms, and further may be defined according to any suitable coordinate system, without departing from the scope of this disclosure.

Additionally, or alternatively the NUI pipeline may include a color image made up of color pixels. The color pixels may be indicative of relative light intensity of a corresponding surface in the observed environment. The light intensity may be recorded for one or more light channels (e.g., red, green, blue, grayscale, etc.). For example, red/green/blue color values may be recorded for every color pixel of the color image. The color image may be generated from color image information output from one or more visible light cameras. Similarly, the NUI pipeline may include an IR image including IR values for every pixel in the IR image. The IR image may be generated from IR image information output from one or more depth cameras.

A virtual skeleton 204 that models the human subject may be recognized or generated based on analysis of the pixels of the depth map 202, a color image, and/or an IR image. It will be understood that such information may be broadly characterized as orientation information. According to an example modeling approach, pixels of the depth map may be assigned a body-part index. The body-part index may include a discrete identifier, confidence value, and/or body-part probability distribution indicating the body part or parts to which that pixel is likely to correspond. Body-part indices may be determined, assigned, and saved in any suitable manner. In some embodiments, body part indexes may be assigned via a classifier that is trained via machine learning.

The virtual skeleton 204 models the human subject with a plurality of skeletal segments pivotally coupled at a plurality of joints characterized by three-dimensional positions. In some embodiments, a body-part designation may be assigned to each skeletal segment and/or each joint. A virtual skeleton consistent with this disclosure may include virtually any type and number of skeletal segments and joints.

In some embodiments, skeletal modeling may include gaze tracking of the human subject's eyes. The human subject's eyes may be assigned a body-part designation. The human subject's eyes may be characterized by a gaze direction. In other embodiments, a gaze direction of the human subject's eyes may be inferred from a position of the human subject's head.

Positional changes in the various skeletal joints and/or segments may be analyzed to identify a gesture 206 performed by the human subject. In particular, a gesture performed by a body part may be identified based on orientation information for that body part. It will be understood that a gesture may be identified according to any suitable gesture recognition technique without departing from the scope of this disclosure. For example, the relative position, velocity, and/or acceleration of one or more joints relative to one or more other joints may be used to identify gestures.

Moreover, it will be appreciated that orientations of body parts other than the body part that performed the gesture may be identified in order to provide contextual information about the human subject. Such orientations may be used to map the gesture to an action. For example, the complete virtual skeleton can be analyzed to determine an orientation of each body part regardless of whether the body part is involved in performing the gesture.

In some embodiments, in cases where multiple human subjects are in the scene imaged by the depth camera, a virtual skeleton may be generated for each of the human subjects. Moreover, orientations of body parts of each of the human subjects may be identified to recognize gestures and/or provide contextual information used to enhance gestures performed by other human subjects.

In some embodiments, objects other than a human subject in the imaged scene may be recognized to provide contextual information of a human subject. Moreover, a human subject's position and orientation relative to an object may be identified to provide contextual information used to enhance gestures performed by the human subject.

An action 208 may be performed by the computing device based on the identified gesture. For example, the identified gesture 206 may be mapped to an action performed by the computing device. It will be understood that the action may control any suitable operation of the computing device. For example, the action may be related to controlling a property of a virtual object in a virtual environment, such as in a video game or other virtual simulation, navigation of a user graphical user interface, execution of an application program, internet browsing, social networking, communication operations, or another suitable computing operation.

In one example, a mapping of the gesture to the action may be determined based on an identified orientation of a second body part that did not perform the gesture. The orientation of the second body part may provide contextual information of the human subject that may be used to determine an appropriate action to be performed for the context. Using contextual information derived from an orientation of the human subject to determine a mapping of a gesture to an action will be discussed in further detail below.

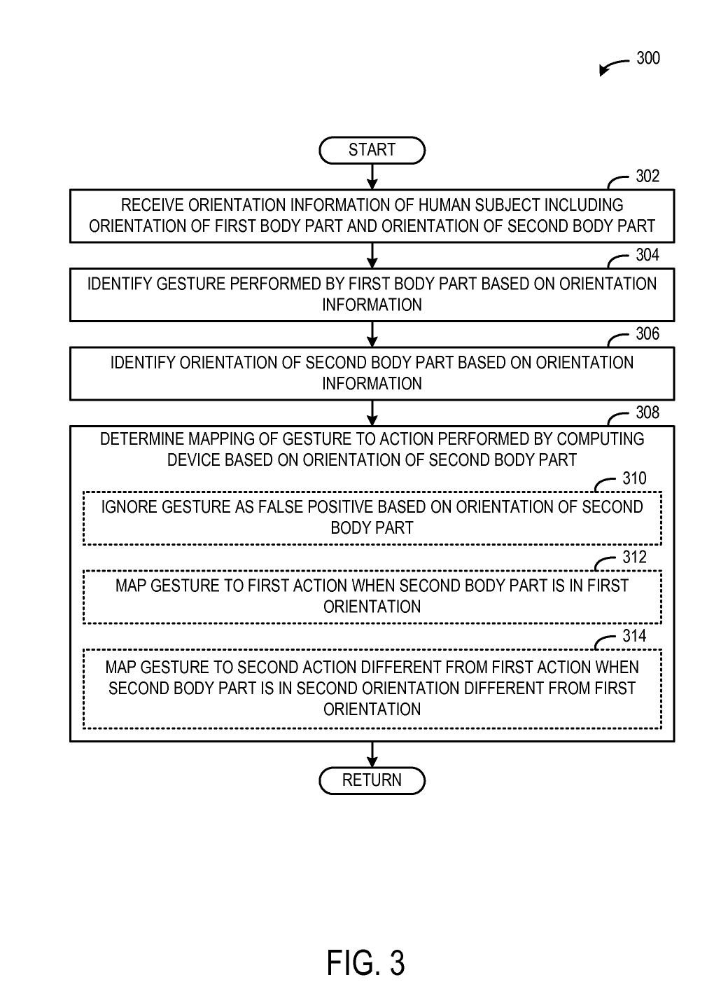

FIG. 3 shows a method 300 for controlling a computing device based on motion of a human subject in accordance with an embodiment of this disclosure. For example, the method 300 may be performed by the computing system 108 shown in FIG. 1.

At 302, the method 300 may include receiving orientation information of a human subject. The orientation information may include an orientation of a first body part and an orientation of a second body part. For example, the orientation information may be representative of a virtual skeleton that models the human subject with a plurality of virtual joints characterized by three-dimensional positions. The virtual skeleton may be derived from a depth video of a depth camera imaging the human subject. It will be appreciated that the first and second body parts may be any suitable body parts of the human subject, and may have a particular designation in a body part index of the virtual skeleton.

At 304, the method 300 may include identifying a gesture performed by the first body part based on the orientation information. At 306, the method 300 may include identifying an orientation of the second body part based on the orientation information. At 308, the method 300 may include determining a mapping of the gesture to an action performed by a computing device based on the orientation of the second body part. In some cases, the action may be performed by the computing device in response to the gesture being performed by the human subject.

In some embodiments, at 310, determining the mapping may further include ignoring the gesture as a false positive based on the orientation of the second body part. For example, some orientations of the second body part may indicate that the human subject's focus or direction of intent may be aimed away from engagement with the computing device, and it may be assumed that the human subject did not intend to perform the gesture. Accordingly, it may align with the assumed expectations of the human subject to ignore the identified gesture.

In some embodiments, at 312, the method 300 may include mapping the gesture to a first action when the second body part is in a first orientation. Further, at 314, the method 300 may include mapping the gesture to a second action different from the first action when the second body part is in a second orientation different from the first orientation. In other words, different orientations of the second body part may indicate different contexts of the human subject and different actions may be more or less appropriate for those different contexts. As such, an action that most appropriately suits the context associated with the orientation may be determined to be mapped to the gesture.

In some embodiments, a plurality of body parts that did not actively perform the gesture may be analyzed to determine mapping of the gesture. For example, a confidence rating of whether a gesture ought to be mapped to a particular action or a false positive status may be determined based on analysis of a plurality of body parts. The confidence rating may increase as orientations of different body parts indicate a context that points to a particular action or status.

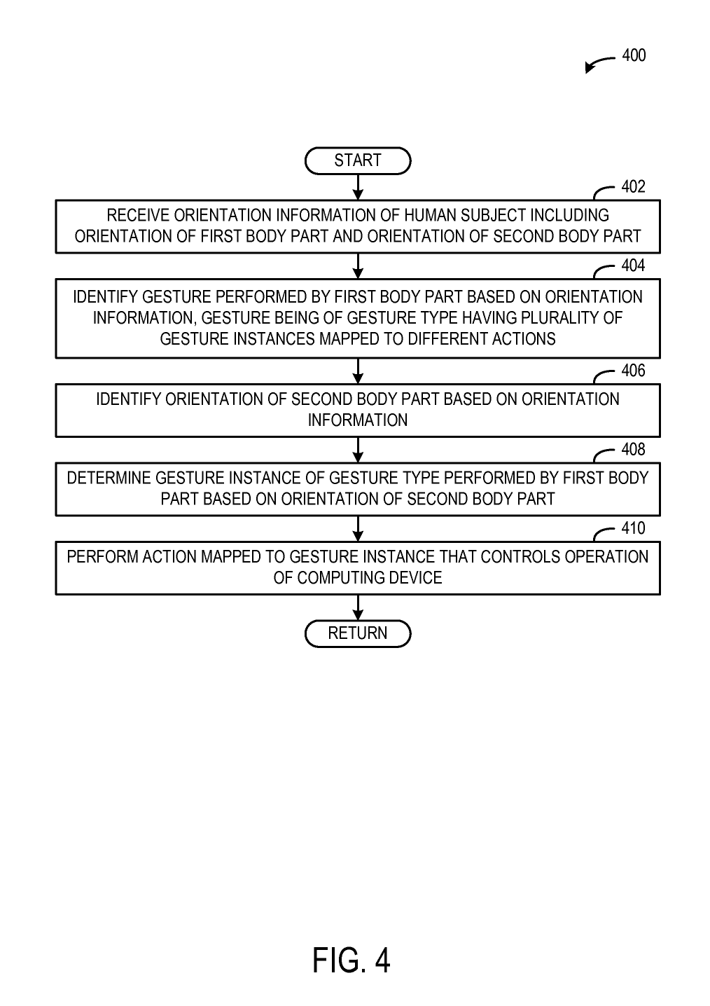

FIG. 4 shows a method 400 for controlling a computing device based on motion of a human subject in accordance with another embodiment of this disclosure. For example, the method 400 may be performed by the computing system 108 shown in FIG. 1. At 402, the method 400 includes receiving orientation information for a first human subject, the orientation information including information regarding an orientation of a first body part and an orientation of a second body part.

At 404, the method 400 comprises identifying a gesture performed by the first body part based on the orientation information. The gesture may be of a gesture type having a plurality of gesture instances. The plurality of gesture instances may be mapped to different actions. Non-limiting examples of gesture types may include pointing, waving, pushing, jumping, ducking, punching, kicking, holding, touching, scrolling, tapping, etc. Each of these gesture types may include a plurality of gesture instances that may be contextually different from one another. It will be appreciated that a gesture having any suitable gesture type may be identified without departing from the scope of this disclosure.

At 406, the method 400 includes identifying an orientation of the second body part based on the orientation information. At 408, the method 400 may include determining a gesture instance of the gesture type performed by the first body part based on the orientation of the second body part. The gesture instance may be dynamically selected from the plurality of gesture instances of the gesture type based on a context of the human subject as indicated by the orientation of the second body part.

In one non-limiting example, a pointing gesture type has gesture instances including pointing at a display, pointing at another human subject, and pointing at an object. In this example, the gesture instance may be determined based on an orientation of the human subject's head (or gaze). It will be understood that any suitable number of different gesture types having any suitable number of different gesture instances may be implemented without departing from the scope of this disclosure.

At 410, the method 400 includes performing an action mapped to the gesture instance that controls operation of the computing device. The action mapped to the gesture instance may be appropriate for the context of the human subject. In other words, different actions may be appropriate for different contexts, such that a first action that is appropriate for a given context may enhance operation of the computing device relative to a second action that is appropriate for a different context.

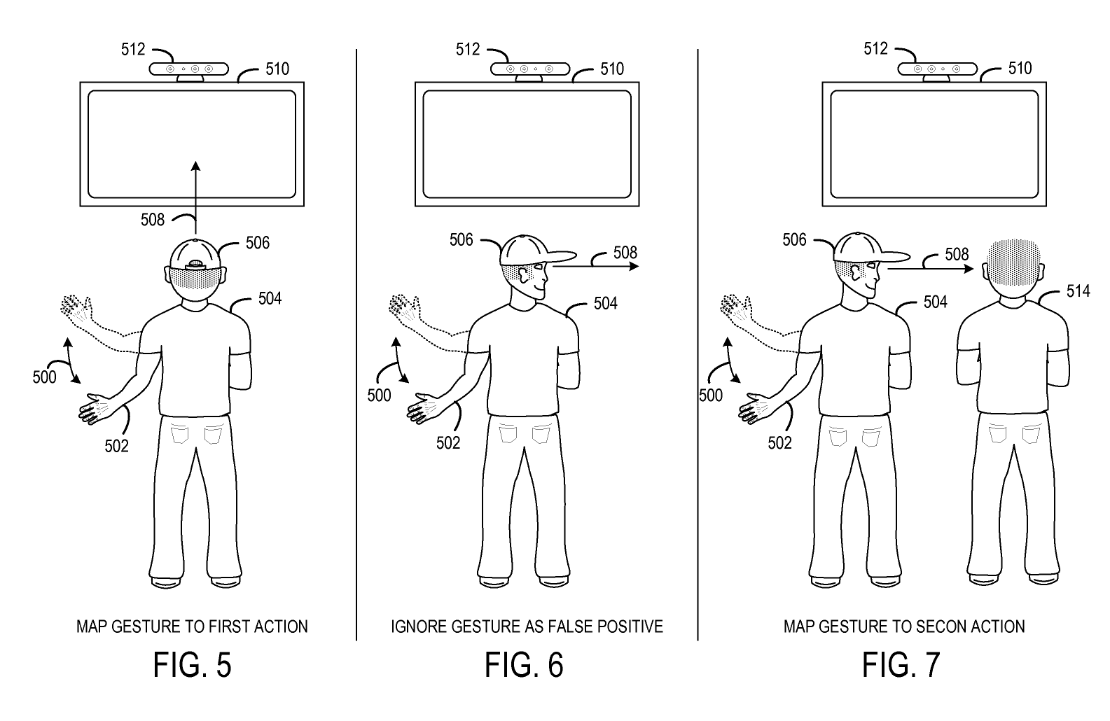

FIGS. 5-15 show example scenarios where a gesture is mapped to different actions based on different orientations of a designated body part of a human subject. Moreover, in some cases, mapping may be further determined based on orientation information of another human subject or object in the imaged scene that may indicate a context of the human subject. Such orientation information may be derived from a depth video of a depth camera imaging the scene, or in any other suitable manner.

FIGS. 5-7 show example scenarios where a waving gesture 500 is performed by an arm 502 of a human subject 504. The waving gesture may be mapped differently based on an orientation of the human subject's head 506. An NUI interface system 512 images an environment including the human subject 504. The NUI interface system is positioned above a display 510. The NUI interface system and the display are operatively coupled with a computing device (not shown).

FIG. 5 shows a scenario where the human subject's head 506 is in an orientation that is pointed toward the display 510. Correspondingly, the human subject's gaze 508 is in an orientation that is looking at the display. The orientations of these associated body parts may indicate that that the human subject is engaged with operation of the display. Accordingly, the waving gesture 500 is mapped to a first action performed by the computing device based on the head of the human subject looking at the display. For example, the first action may control operation of a graphical user interface presented on the display.

FIG. 6 shows a scenario where the human subject's head 506 is in an orientation that is pointed away from the display 510. Correspondingly, the human subject's gaze 508 is in an orientation that is looking away from the display. The orientations of these associated body parts may indicate that that the human subject is not engaged with operation of the display, and thus the waving gesture 500 may be ignored as a false positive based on the head looking away from the display. In this case, no action may be performed in response to the waving gesture.

FIG. 7 shows a scenario where a second human subject 514 is included in the environment. The NUI interface system 512 may identify the second human subject and determine orientation information of the second human subject that may provide additional context for the waving gesture. Like the scenario shown in FIG. 6, the human subject's head 506 is in an orientation that is pointed away from the display 510. Correspondingly, the human subject's gaze 508 is in an orientation that is looking away from the display. However, the NUI interface system recognizes that the human subject's head 506 is further pointed at the second human subject 514, such that the human subject is looking at the second human subject. Accordingly, the waving gesture 500 is mapped to a second action performed by the computing device based on the head of the human subject looking at the second human subject. The second action may be different from the first action. In some cases, the second action may be related to the second human subject. For example, the second action may include passing control of the display from the human subject 504 to the second human subject 514.

These scenarios may be characterized in terms of a gesture type having a plurality of different gesture instances mapped to different actions. In particular, the scenarios shown in FIGS. 5-7 depict the human subject performing a waving type gesture having a waving at display instance (FIG. 5), a waving away from display instance (FIG. 6), and a waving at another human subject instance (FIG. 7). These different gesture instances may be determined based on the orientation of the human subject's head.

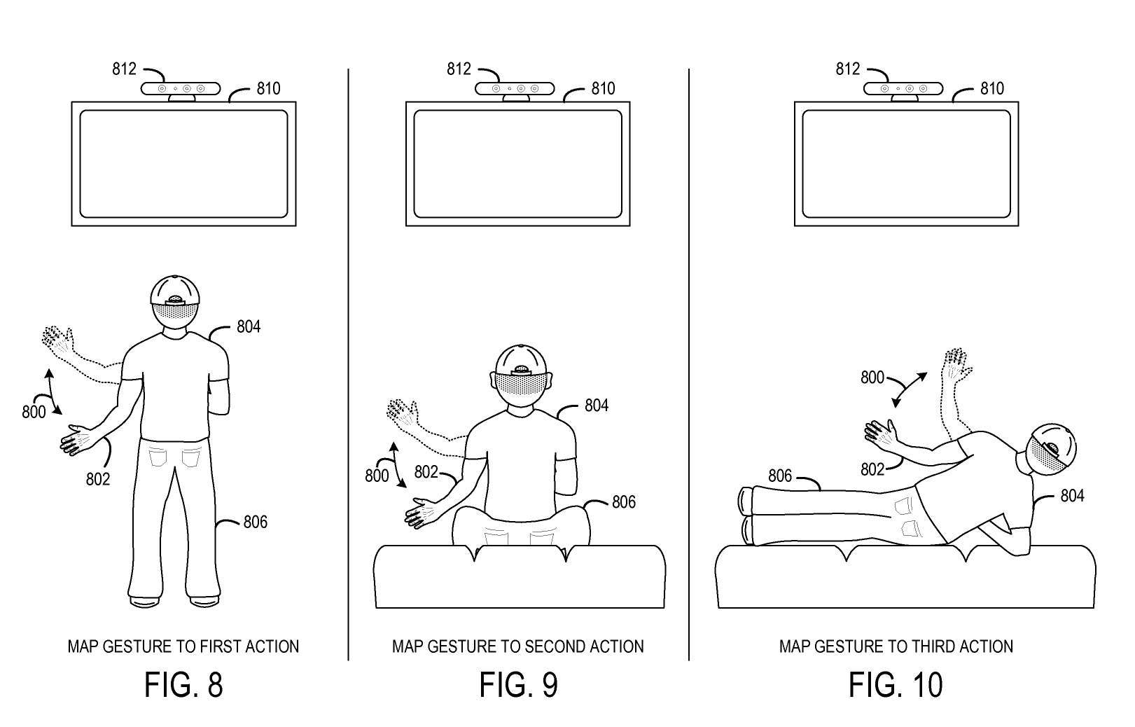

FIGS. 8-10 show example scenarios where a waving gesture 800 is performed by an arm 802 of a human subject 804. The waving gesture may be mapped differently based on an orientation of the human subject's legs 806. An NUI interface system 812 images an environment including the human subject 804. The NUI interface system is positioned above a display 810. The NUI interface system and the display are operatively coupled with a computing device (not shown).

FIG. 8 shows a scenario where the human subject's legs 806 are in a standing position while the arm 802 is performing the waving gesture 800. The waving gesture 800 is mapped to a first action performed by the computing device based on the legs being in the standing position.

FIG. 9 shows a scenario where the human subject's legs 806 are in a sitting position while the arm 802 is performing the waving gesture 800. The waving gesture 800 is mapped to a second action performed by the computing device based on the legs being in the sitting position. For example, the first action may be different from the second action.

FIG. 10 shows a scenario where the human subject's legs 806 are in a laying position while the arm 802 is performing the waving gesture 800. The waving gesture 800 is mapped to a third action performed by the computing device based on the legs being in the laying position. For example, the third action may be different from the first action and the second action. In some embodiments, one or more these actions may indicate a false positive status, and the waving gesture may be ignored as a false positive.

In some embodiments, a gesture of the human subject may be adjusted relative to the user's orientation and account for an angle of the human subject or a body part of the human subject relative to the NUI interface system. In particular, expectations around motions to perform gestures can also be adjusted based on orientation. For example, if the human subject is standing, then the human subject's arms may have a larger range of motion relative to when the human subject is sitting or laying down. In particular, once sitting or laying it may be more difficult to perform actions near the waist or those that require moving an arm a larger distance.

In one example, an action may be mapped to a first gesture performed by a first body part when a second body part that does not perform the first gesture is in a first orientation. Further, the action may be mapped to a second gesture different from the first gesture when the second body part is in a second orientation different from the first orientation. In some cases, the second gesture may be performed by the first body part. In some cases, the second gesture may be performed by a body part other than the first body part. For example, an action may be mapped to a waist-high waving gesture when a human subject is standing, and the action maybe mapped to an over-head waving gesture when the human subject is sitting.

These scenarios may be characterized in terms of a gesture type having a plurality of different gesture instances mapped to different actions. In particular, the scenarios shown in FIGS. 8-10 depict the human subject performing a waving type gesture having a standing and waving instance (FIG. 8), a sitting and waving instance (FIG. 9), and a laying and waving instance (FIG. 10). These different gesture instances may be determined based on the orientation of the human subject's legs.

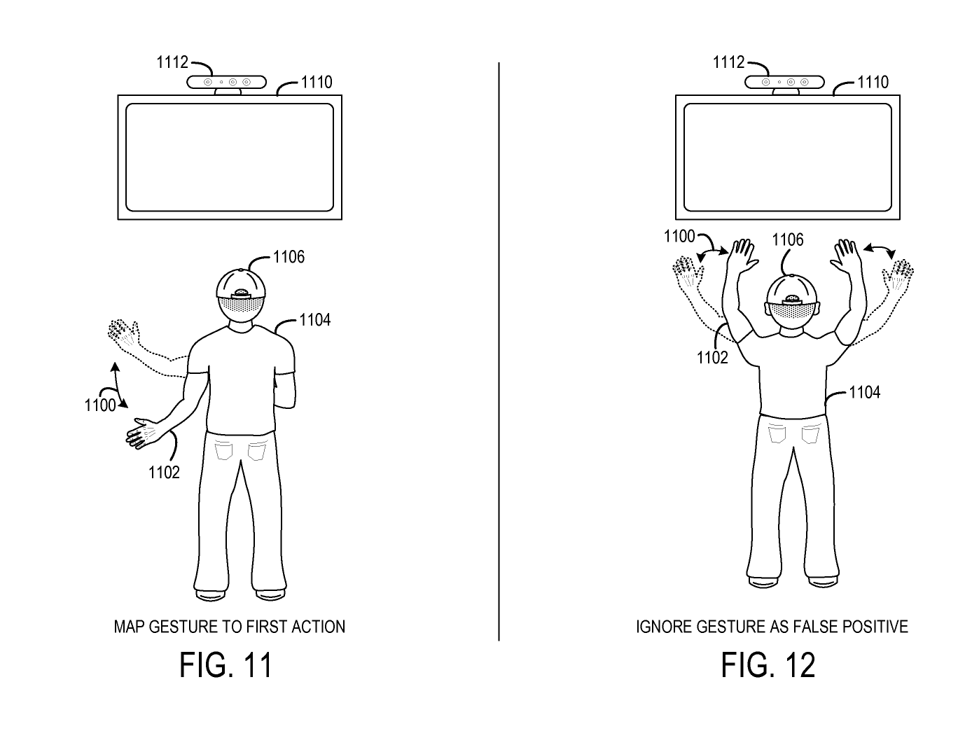

FIGS. 11 and 12 show example scenarios where a waving gesture 1100 is performed by an arm 1102 of a human subject 1104. The waving gesture may be mapped differently based on an orientation of the human subject's head 1106 relative to the human subject's arms 1102. An NUI interface system 1112 images an environment including the human subject 1104. The NUI interface system is positioned above a display 1110. The NUI interface system and the display are operatively coupled with a computing device (not shown).

FIG. 11 shows a scenario where the human subject's head 1106 is positioned above the human subject's arm 1102 while the arm is performing the waving gesture 1100. The waving gesture 1100 is mapped to a first action performed by the computing device based on the head being above the arm.

FIG. 12 shows a scenario where the human subject's head 1106 is positioned below the human subject's arm 1102 while the arm is performing the waving gesture 1100. The waving gesture 1100 is ignored as being a false positive based on the head being positioned below the arm. In this case, the arms being positioned above the head may indicate that the human subject has become excited and is cheering, and thus may not intend to perform the gesture to interact with the computing device.

In some embodiments, a speed at which a gesture is performed may provide further contextual information that may be used to determine a mapping of a gesture to an action or whether to ignore the gesture as a false positive. In one example, if a speed of a gesture is greater than a threshold or another body part that does not perform the gesture reaches a speed that is greater than a threshold, then the gesture may be ignored as a false positive. If the gesture is performed at a speed less than the threshold, then the gesture may be mapped to an action.

Alternatively, these scenarios may be characterized in terms of a gesture type having a plurality of different gesture instances mapped to different actions. In particular, the scenarios shown in FIGS. 11 and 12 depict the human subject performing a waving type gesture having a waving below head instance (FIG. 11) and a waving above head instance (FIG. 12). These different gesture instances may be determined based on the orientation of the human subject's head relative to the human subject's arm(s).

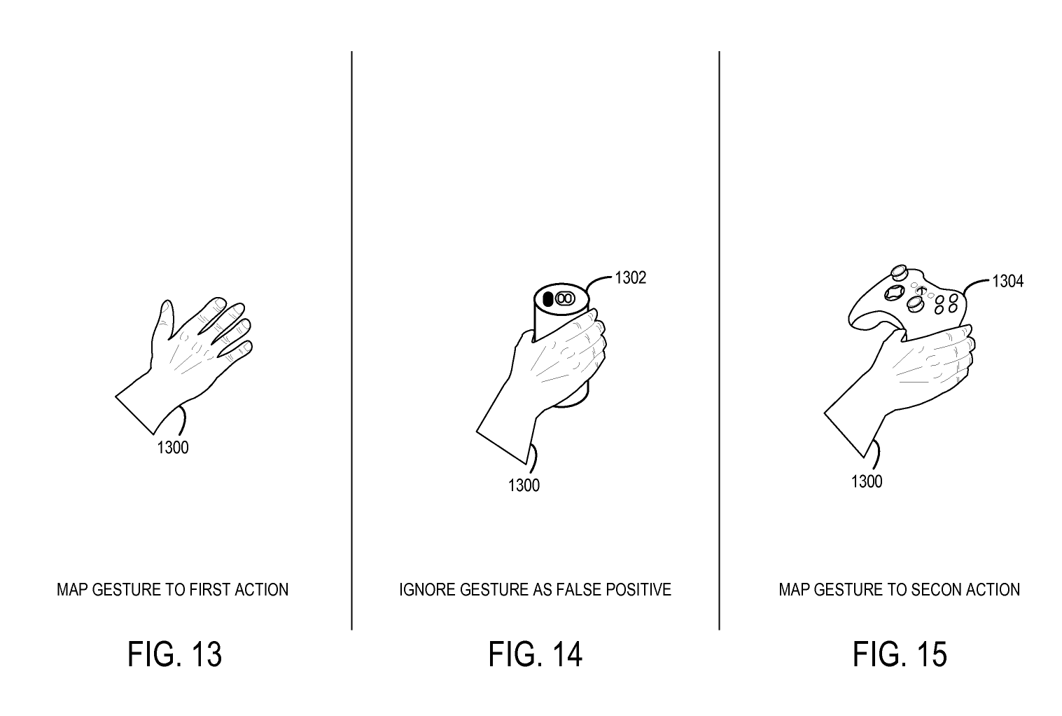

FIGS. 13-15 show example scenarios where a gesture is mapped differently based on an orientation of a human subject's hand 1300. In some cases, the gesture may be performed by the hand. In some cases, the gesture may be performed by a body part other than or in addition to the hand.

FIG. 13 shows a scenario where the hand 1300 is in an orientation where the hand is empty while the gesture is being performed. Accordingly, the gesture may be mapped to a first action based on the orientation of the hand being empty.

FIG. 14 shows a scenario where the hand 1300 is in an orientation where the hand is holding an object—a soda can 1302. Because the hand is holding the soda can as determined from the orientation of the fingers and the presence of the can, it may be assumed the human subject does not intend to perform the gesture. Accordingly, the gesture may be ignored as a false positive based on the hand holding the object.

FIG. 15 shows a scenario where the hand 1300 is in an orientation for holding a gamepad controller 1304. The gamepad controller 1304 may be operatively coupled with the computing device. Further, the computing device may recognize that the hand is holding the gamepad controller, for example via image recognition, received gamepad controller input, or a combination thereof. The hand holding the gamepad controller may represent a particular case of the orientation where the hand is holding an object. As such, instead of ignoring the gesture as a false positive, the gesture may be mapped to a second action different from the first action. For example, the second action may relate to operation of the gamepad controller. It will be understood that this scenario may apply to any suitable secondary device in communication with the computing device. Non-limiting examples of applicable secondary devices include a gesture prop device (e.g., a bat, tennis racket, blaster, light saber, etc.), a smartphone, a tablet computing device, a laptop computing device, or another suitable secondary device.

In some embodiments, the methods and processes described herein may be tied to a computing system of one or more computing devices. In particular, such methods and processes may be implemented as a computer-application program or service, an application-programming interface (API), a library, and/or other computer-program product.

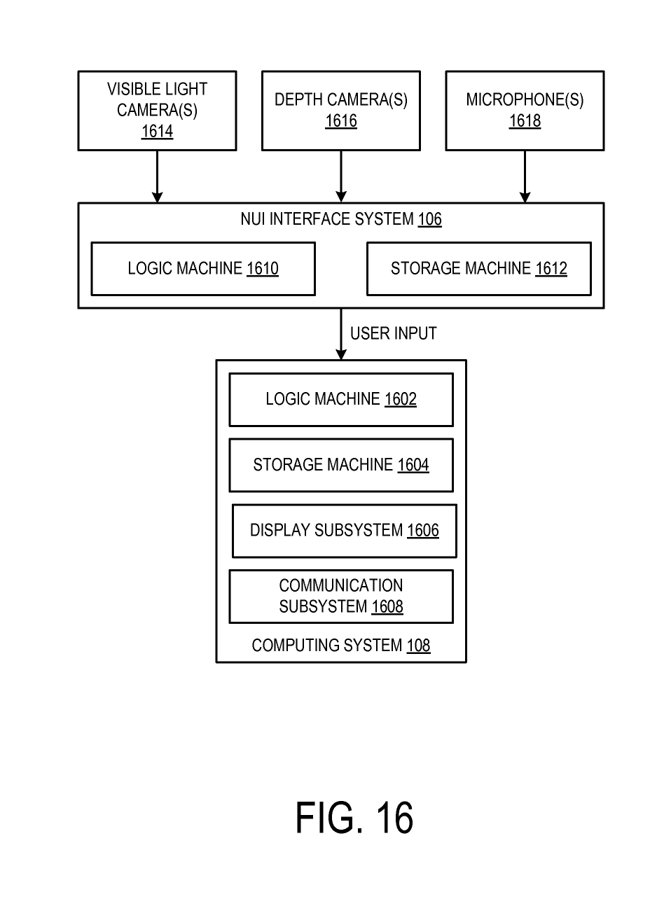

FIG. 16 schematically shows a non-limiting embodiment of a computing system 108 that can enact one or more of the methods and processes described above. Computing system 108 is shown in simplified form. Computing system 108 may take the form of one or more personal computers, server computers, tablet computers, home-entertainment computers, network computing devices, gaming devices, mobile computing devices, mobile communication devices (e.g., smart phone), and/or other computing devices.

Computing system 108 includes a logic machine 1602 and a storage machine 1604. Computing system 108 may optionally include a display subsystem 1606, a communication subsystem 1608, and/or other components not shown in FIG. 16.

Logic machine 1602 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 1604 includes one or more physical devices configured to hold instructions executable by the logic machine to implement the methods and processes described herein. When such methods and processes are implemented, the state of storage machine 1604 may be transformed—e.g., to hold different data.

Storage machine 1604 may include removable and/or built-in devices. Storage machine 1604 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 1604 may include volatile, nonvolatile, dynamic, static, read/write, read-only, random-access, sequential-access, location-addressable, file-addressable, and/or content-addressable devices.

It will be appreciated that storage machine 1604 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 1602 and storage machine 1604 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 108 implemented to perform a particular function. In some cases, a module, program, or engine may be instantiated via logic machine 1602 executing instructions held by storage machine 1604. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 1606 may be used to present a visual representation of data held by storage machine 1604. This visual representation may take the form of a graphical user interface (GUI). As the herein described methods and processes change the data held by the storage machine, and thus transform the state of the storage machine, the state of display subsystem 1606 may likewise be transformed to visually represent changes in the underlying data. Display subsystem 1606 may include one or more display devices utilizing virtually any type of technology. Such display devices may be combined with logic machine 1602 and/or storage machine 1604 in a shared enclosure, or such display devices may be peripheral display devices.

When included, communication subsystem 1608 may be configured to communicatively couple computing system 108 with one or more other computing devices. Communication subsystem 1608 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 108 to send and/or receive messages to and/or from other devices via a network such as the Internet.

As noted above, NUI interface system 106 may be configured to provide user input to computing system 108. To this end, the NUI interface system includes a logic machine 1610 and a storage machine 1612. To detect the user input, the NUI interface system receives low-level input (i.e., signal) from an array of sensory components, which may include one or more visible light cameras 1614, depth cameras 1616, and microphones 1618. Other example NUI componentry may include one or more infrared or stereoscopic cameras; a head tracker, eye tracker, accelerometer, and/or gyroscope for motion detection and/or intent recognition; as well as electric-field sensing componentry for assessing brain activity. In some embodiments, the NUI interface system may comprise or interface with one or more user-input devices such as a keyboard, mouse, touch screen, or game controller.

The NUI interface system processes the low-level input from the sensory components to yield an actionable, high-level input to computing system 108. Such action may generate corresponding text-based user input or other high-level commands, which are received in computing system 108. In some embodiments, NUI interface system and sensory componentry may be integrated together, at least in part. In other embodiments, the NUI interface system may be integrated with the computing system and receive low-level input from peripheral sensory components.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A method for controlling a computing device based on motion of a human subject, the method comprising:
receiving orientation information of the human subject including information regarding an orientation of a first body part and an orientation of a second body part;
identifying a gesture performed by the first body part based on the orientation information;
identifying an orientation of the second body part based on the orientation information;
determining a mapping of the gesture to an action performed by the computing device based on the orientation of the second body part.

2. The method of claim 1, wherein the orientation information is representative of a virtual skeleton that models the human subject with a plurality of virtual joints characterized by three-dimensional positions, the virtual skeleton derived from a depth video of a depth camera imaging the human subject.

3. The method of claim 1, wherein determining the mapping further includes ignoring the gesture as a false positive based on the orientation of the second body part.

4. The method of claim 1, wherein determining the mapping includes mapping the gesture to a first action when the second body part is in a first orientation and mapping the gesture to a second action different from the first action when the second body part is in a second orientation different from the first orientation.

5. The method of claim 4, wherein the second body part includes a head of the human subject, the first orientation includes the head of the human subject looking at a display, and the second orientation includes the head of the human subject looking away from the display.

6. The method of claim 4, wherein the second body part includes legs of the human subject, the first orientation of the legs includes a standing position, and the second orientation of the legs includes a sitting position or a laying position.

7. The method of claim 4, wherein the second body part includes a hand, the first orientation of the hand includes the hand being empty, and the second orientation of the hand includes the hand holding an object.

8. The method of claim 7, further comprising:
recognizing that the object that the hand is holding is a secondary device in communication with the computing device, and the second action relating to operation of the secondary device.

9. A computing device comprising:
a logic machine;
a storage machine holding instructions that when executed by the logic machine:
receive orientation information of a first human subject including information regarding a first body part and a second body part;
identify a gesture performed by the first body part of the human subject based on the orientation information;
if the second body part is in a first orientation, determine a mapping of the gesture to a first action performed by the computing device based on the orientation of the second body part; and
if the second body part is in a second orientation, ignore the gesture as a false positive.

10. The computing device of claim 9, wherein the orientation information is representative of a virtual skeleton that models the first human subject with a plurality of virtual joints characterized by three-dimensional positions, the virtual skeleton derived from a depth video of a depth camera imaging the first human subject.

11. The computing device of claim 9, wherein the second body part includes a head of the first human subject, the first orientation includes the head of the first human subject looking at a display, and the second orientation includes the head of the first human subject looking away from the display.

12. The computing device of claim 11, wherein the storage machine holds instructions that when executed by the logic machine:
identify a second human subject based on the orientation information;
recognize that the head of the first human subject is looking away from the display and toward the second human subject; and
determine a mapping of the gesture to a second action performed by the computing device based on the head of the first human subject looking at the second human subject.

13. The computing device of claim 9, wherein the first body part includes an arm of the human subject, the second body part includes a hand, the first orientation of the hand includes the hand being empty, and the second orientation of the hand includes the hand holding an object.

14. The computing device of claim 12, wherein the storage machine holds instructions that when executed by the logic machine:
recognize that the object that the hand is holding is a secondary device in communication with the computing device, and wherein determining the mapping includes mapping the gesture to a second action different from the first action and related to operation of the secondary device.

15. The computing device of claim 9, wherein the second body part includes legs of the first human subject, the first orientation of the legs includes a standing position, and the second orientation of the legs includes a sitting position or a laying position.

16. The computing device of claim 9, wherein the first body part includes an arm of the first human subject, the second body part includes a head of the first human subject, the first orientation includes the head being positioned above the arm, and the second orientation includes the head being positioned below the arm.

17. A method for controlling a computing device based on motion of a first human subject, the method comprising:
receiving orientation information for a first human subject including information regarding an orientation of a first body part and an orientation of a second body part;
identifying a gesture performed by the first body part based on the orientation information, the gesture being of a gesture type having a plurality of gesture instances mapped to different actions;
identifying an orientation of the second body part based on the orientation information;
determining a gesture instance of the gesture type performed by the first body part based on the orientation of the second body part; and
performing an action mapped to the gesture instance that controls operation of the computing device.

18. The method of claim 17, wherein the orientation information is representative of a virtual skeleton that models the first human subject with a plurality of virtual joints characterized by three-dimensional positions, the virtual skeleton derived from a depth video of a depth camera imaging the first human subject.

19. The method of claim 17, wherein the gesture type includes a gesture instance associated with a false positive status, and if the gesture instance associated with the false positive status is determined to be performed by the first body part, then ignoring the gesture as a false positive.

20. The method of claim 17, wherein the second body part includes a head of the first human subject, a first orientation of the head including the head looking at a second human subject, a second orientation of the head including the head looking at a display, a third orientation of the head including the head looking at a controller held by the human subject, and each of the first orientation, the second orientation, and the third orientation being associated with a different gesture instance to which a different action is mapped.
